(19) United States
(12) Patent Application Publication
(10) Pub. No.: US 2026/0225521 A1
(43) Pub. Date: Aug. 6, 2026

(54) LOUDSPEAKER ASSEMBLY WITH LIGHTING EFFECT, AND VEHICLE

(71) Applicant: MERCEDES-BENZ GROUP AG, Stuttgart (DE)

(72) Inventor: Klaus RÖHM, Schwaikheim (DE)

(21) Appl. No.: 19/151,047

(22) PCT Filed: Nov. 24, 2023
(86) PCT No.: PCT/EP2023/083042

§ 371 Date: Jul. 25, 2025

(30) Foreign Application Priority Data
Jan. 27, 2023 (DE) 10 2023 000 243.7

(51) Int. Cl. B60Q 3/76; B60Q 3/62; F21V 7/00; F21W 106/00; H04R 1/02

(52) U.S. Cl. CPC B60Q 3/76; B60Q 3/62; F21V 7/0008; H04R 1/025; H04R 1/028; F21W 2106/00; H04R 2499/13

(57) ABSTRACT

A loudspeaker assembly providing a lighting effect includes a screen formed by a lamella grille having at least two lamellas extending in a first direction. Some of the lamellas are formed by a light-guiding structure having an integrated reflection structure. On a lamella underside of the reflection structure a cutout extends in the first direction and into which the light-guiding structure is recessed so that light coupled out of the light-guiding structure is cast onto a lamella top side of the adjacent lamella lying. The light-guiding structures, the coupling-in bridge, and at least one light source form the lighting device. Light from the light source is coupled into the coupling-in bridge, which extends in a second direction orthogonal to the first direction, and the light-guiding structures contact the coupling-in bridge or are integral, so that light that propagates in coupling-in bridge is coupled into the light-guiding structures.

### BACKGROUND AND SUMMARY OF THE INVENTION

Exemplary embodiments of the invention relate to a loudspeaker assembly with a lighting effect, as well as to a vehicle having such a loudspeaker assembly.

In order to generate an “eye-catching effect”, loudspeakers with integrated lighting are known. Such loudspeakers can be installed in a vehicle, thereby realizing a particularly attractive appearance for the occupants of the vehicle.

Typically, loudspeakers can be integrated in the A-pillar of the vehicle and in the driver and front passenger doors. The loudspeakers are provided with a screen for protection purposes, for example a perforated screen. In a plan view of this screen, in known embodiments, lamps can be arranged behind the loudspeaker in order to backlight it. The thus radiated light is reflected on the side of the screen facing the loudspeaker in the direction of the loudspeaker. The loudspeaker can thus be visible to an observer, which may be undesirable. Another disadvantage is that the loudspeaker is “in the way” of the light, meaning that no two-dimensional continuous light pattern can be generated. In order to ensure uniform lighting, in such a variant the loudspeaker has to be arranged centrally behind the screen, which restricts the degree of design freedom. This can lead to problems when it is necessary to place the loudspeakers off-center for perfect acoustics.

A loudspeaker cover that can be lit is also known from DE 10 2020 003 325 A1. A supportive structure functioning as a light guide is arranged between loudspeaker and cover screen. Light is coupled into the light guide at an outer edge of the supportive structure using lighting means, which light then exits again at the side. This enables diffuse lighting of the loudspeaker, with the light exiting the light guide exiting the sound holes in the cover screen in the direction of an observer. The cover screen of the loudspeaker is thus backlit. The cover screen and the supportive structure have a different geometry. For instance, the cover screen is designed as a honeycomb grid and the protective structure as a bar structure of concentric circles interconnected via radial struts. The cover screen serves in particular for contact protection and the supporting structure for absorbing mechanical loads and for transmitting the light. When the lighting is activated, the supporting structure stands out from the cover screen, which detracts from the visual appearance of the loudspeaker cover.

Furthermore, US 2018/0035187 A1 discloses a light and loudspeaker driver device. According to one embodiment, the device comprises a loudspeaker with a loudspeaker grille. LEDs illuminating the top side of the respective adjacent lamella are arranged on the respective undersides of the lamellas of the loudspeaker grille.

Furthermore, DE 20 2006 015 232 U1 discloses a cover device for a loudspeaker. The cover device comprises a frame designed as a light guide. A loudspeaker grille can be fastened on the frame and thus backlit.

Furthermore, DE 10 2022 100 064 A1 discloses an interior component for vehicles. The interior component comprises a loudspeaker cover having a carrier designed at least in sections as a light guide.

In addition, an illuminated loudspeaker grille is known from DE 10 2020 003 925 A1. In this case, light is coupled through a light source arranged on the side of the loudspeaker grille into a grille structure of the loudspeaker grille.

Exemplary embodiments of the present invention are directed to an improved loudspeaker assembly with a lighting effect, which overcomes the disadvantages described hereinabove.

A generic loudspeaker assembly with lighting effect, comprising at least one loudspeaker, a screen covering the at least one loudspeaker in the direction of a sound emission direction, and a lighting device for shining light onto the screen is refined according to the invention such that
the screen is formed by a lamella grille comprising at least two lamellas extending substantially in a first direction;
at least some of the lamellas are formed in each case by a light-guiding structure and a reflection structure integral therewith, wherein the reflection structure has on a lamella underside a cutout extending in the first direction and into which the light-guiding structure is recessed in such a way that light which can be coupled out of the light-guiding structure can be cast onto a lamella top side of the adjacent lamella lying therebelow; and
the respective light-guiding structures, together with a coupling-in bridge and at least one light source, form the lighting device, wherein light can be coupled by means of the at least one light source light into the coupling-in bridge, the coupling-in bridge extends in a second direction orthogonal to the first direction and the light-guiding structures contact the coupling-in bridge or are designed as a single piece with the latter, so that light that propagates in the coupling-in bridge can be coupled into the light-guiding structures.

With the aid of the loudspeaker assembly according to the invention, a particularly visually attractive staging of the screen can be realized, which improves the aesthetics of the loudspeaker assembly and thus results in an attractive appearance. The light source can comprise one or also multiple lamps such as single-color or multicolored LEDs. Light emitted from the light source is distributed via the coupling-in bridge to the individual light-guiding structures of the lamellas, which illuminate the respective adjacent lamellas. It is thus possible to light up the screen of the loudspeaker assembly without an observer being able to see the light source. The loudspeaker lying behind the screen in the viewing direction does not visually interrupt the surface lighting, which improves the aesthetics even further. The loudspeaker assembly according to the invention can be designed in such a way that light reflected from the lamella top side of the lamellas is mainly scattered and/or reflected away from the loudspeaker assembly, so that an observer can only see the loudspeaker lying behind the lamella grille with difficulty, if at all. Depending on the observer's preferences, this can improve the aesthetic appearance of the loudspeaker assembly even further.

It is also possible for sufficient light to be cast in the direction of the loudspeaker, whereby the loudspeaker is diffusely illuminated in such a way that it is at least weakly visible to an observer. Angles of inclination of the lamellas, the lamella length and the spacing between lamellas can be adapted in order to control the light portion that can be cast onto the loudspeaker.

The loudspeaker assembly can be integrated in a superordinate structure, for example the A-pillar of a vehicle or a vehicle door, from which the loudspeaker assembly stands out in a particularly aesthetic and attractive manner owing to the lighting effect, in particular in poor lighting conditions or in darkness. The lighting that is constant over the entire surface of the lamella grille supports this effect.

The loudspeaker assembly can have further components, such as a housing designed to accommodate the loudspeaker and is covered with the screen. This housing can then be customized to match the superordinate structure and to make it easier to integrate the loudspeaker assembly on the superordinate structure and to protect it from dirt and moisture.

Due to the integral design of the light-guiding structure and reflection structure, it is possible to produce the screen and therefore the loudspeaker assembly in a simple and cost-effective manner. The light-guiding structure is concealed from view to the observer by the reflection structure, so that the light-guiding structure cannot be perceived directly. This improves the visual appearance even further.

It is possible for only some of the lamellas of the lamella grille or also preferably all of the lamellas to have such a light-guiding structure and reflection structure. Lamellas that are not intended to be lit up have an adjacent lamella above them that does not have a light-guiding structure. Therefore, the corresponding lamella is not illuminated either and appears dark. This means that interruptions can be introduced in a targeted way into the light pattern should this be required for design reasons.

The coupling-in bridge can be situated in front of or behind the lamella grille in a plan view of the loudspeaker assembly. Preferably, the coupling-in bridge is arranged behind the lamellas, i.e., between lamella grille and loudspeaker, which makes it more difficult for an observer to see the coupling-in bridge. This also contributes to the aesthetic appearance of the loudspeaker assembly. The coupling-in bridge can be arranged as viewed in the first direction at any point on the lamella grille, for example centrally or preferably in an edge region. Particularly if the coupling-in bridge is arranged in the edge region, it is even more difficult for an observer to see the coupling-in bridge. By contrast, mounting the bridge inside the area of the lamella grille ensures homogeneous distribution of light even when lamella grilles are comparatively large. If the width of the lamellas exceeds a certain amount, there could be the risk that lamella regions remote from the coupling-in bridge are increasingly poorly illuminated, to the detriment of homogeneous lighting. However, such an effect may also be desirable and required depending on the design specifications.

One advantageous refinement of the loudspeaker assembly provides that the lamella grille is manufactured by two-component injection molding. This further supports cost-effective and simple manufacture of the lamella grille. With the aid of injection molding, series parts can be manufactured cost-effectively with high reliability and in high piece numbers. In this case, two different components are used to form the light-guiding structure and the reflection structure. Particularly preferably, a material having a comparatively high transparency for light, such as polymethyl methacrylate, is used to form the light-guiding structure and an opaque material such as a light-impermeable plastic is used to form the reflection structure. The color of the material used for the reflection structure can be customized to the use conditions of the loudspeaker assembly. For instance, darker colors such as grey or black but also lighter colors such as beige or white can be used. The reflection structure can also be coated and/or patterned at least in the region of the lamella top side, in order to set a certain degree of scattering or reflectance.

In accordance with a further advantageous design of the loudspeaker assembly, for at least one of the lamellas, the cutout of the reflection structure and the respective light-guiding structure recessed therein extend over the full width of the respective lamella in the first direction. This helps with lighting the screen uniformly. In particular, the full area of the lamella grille is thus illuminated, which ensures an even sharper contour and thus demarcation of the illuminated loudspeaker assembly from a superordinate structure. Preferably, all lamellas have a correspondingly continuous cutout with a correspondingly recessed light-guiding structure. However, individual lamellas could also have a cutout shortened in the first direction with a correspondingly matching light-guiding structure, in order to customize the visual appearance of the loudspeaker assembly for design reasons when the lighting is switched on.

A further advantageous design of the loudspeaker assembly also provides that at least one lamella top side that can have light shone on it through an adjacent lamella is provided with a light-reflecting coating or the reflection structure of the respective lamella comprises a light-reflecting material. “Light-reflecting” in this connection means a material which can be used to generate a reflective surface. By way of example, the lamella top sides can be chrome-plated or have a coating that gives them a chrome-plated appearance. This can ensure a comparatively high degree of reflectivity, whereby a particularly large amount of light is reflected in the direction of the surroundings. The lamellas of the lamella grilles accordingly have a particularly bright appearance. Individual lamellas can also be coated with a different material or consist of a different material. This means that the degree of reflectivity of the individual lamellas can be configured in different ways. This can be used to customize the visual appearance to different requirements. Multi-component injection molding can also be used to produce this effect.

In accordance with a further advantageous design of the loudspeaker assembly, the coupling-in bridge is provided with a light-impermeable cover on its side in a plan view of the lamella grille. In this case, the coupling-in bridge can be provided fully or else only partially with the cover. A complete cover has the effect that the coupling-in bridge is no longer visible to an observer. In this case, the loudspeaker assembly can also be connected to a superordinate structure in such a way that parts of the superordinate structure conceal the coupling-in bridge. The cover can also have cutouts, so that light that propagates in the coupling-in bridge can exit through these cutouts in the direction of the surroundings. This can be used, for example, to incorporate self-illuminating pictograms or logos in the loudspeaker assembly. The light-impermeable cover can rest directly or indirectly on the coupling-in bridge or be arranged thereon. If the coupling-in bridge is on the lamella grille in the viewing direction, the cover can rest directly on the coupling-in bridge. If, by contrast, the coupling-in bridge is arranged between the loudspeaker and lamella grille, the light-impermeable cover can also rest on the lamella grille or be fastened thereto.

The coupling-in bridge can also be designed in such a way that it has a reduced transmission capacity on the side facing the observer so that a larger portion of light propagates within the coupling-in bridge and little to no light “bleeds out” in the direction of the observer. Proven light-guiding techniques are employed for this purpose.

A further advantageous design of the loudspeaker assembly also provides that the ratio of lamella length, angle of inclination of the lamellas, and spacing between the lamellas in the second direction is such that, in a plan view of the lamella grille, the individual lamellas block the view of the region lying behind the lamella grille. When the loudspeaker assembly is viewed directly from above, the loudspeaker cannot be seen by an observer. This is favorable for the aesthetic appearance of the loudspeaker assembly if the loudspeakers are not intended to be directly visible.

In a further preferred embodiment, the angle of inclination of the lamellas can also be freely adjusted. To this end, proven techniques are employed, such as a geared or continuously variable adjustment. Such an angle of inclination adjustment is known, for example, for adjusting the exit angle of an air stream of a vehicle ventilation system. As a result, an observer is able to adapt the visual appearance of the loudspeaker assembly during use to their own preferences.

The ratio of lamella length, angle of inclination and spacing can also be varied in such a way that the loudspeaker lying behind the lamella grille cannot be seen in a first inclination angle range and the loudspeaker can be seen in a second inclination angle range. As the angle of inclination increases, the portion of the light reflected in the direction of the loudspeaker can also be increased, meaning that the loudspeaker appears increasingly brighter.

In accordance with a further advantageous design of the loudspeaker assembly, at least one loudspeaker is arranged outside a center of an area of the lamella grille in a plan view of the lamella grille. With the aid of the loudspeaker assembly according to the invention, lighting of the screen can be realized in which the screen itself is illuminated with light and is thus diffusely illuminated but the loudspeaker behind it remains dark. Thus, the position of the loudspeaker no longer plays a role for the visual appearance of the loudspeaker assembly, so that it can be placed at any point, i.e., even off-center.

Thus, acoustic requirements can be taken into account when forming the loudspeaker assembly, without these having a disadvantageous influence on the visual appearance.

In an alternative design of the loudspeaker assembly, in which the loudspeaker is also lit up, it is likewise advantageously possible to place the loudspeaker off-center, since the position of the loudspeaker has no effect on the distribution of light on the lamellas, unlike in the case of loudspeaker backlighting.

A further advantageous design of the loudspeaker assembly provides that the at least one light source can be controlled to generate a dynamic lighting effect in such a way that the brightness and/or color of the light emitted by the light source can be varied over time. In general, the light source could emit static light. If the light source is activated, the light source or the one or more lamps of the light source could thus radiate light of the same color or respectively the same brightness. However, a particular effect can be generated if the brightness and/or the color of the lamp(s) of the light source are changed. When starting a vehicle ignition, switching on vehicle lighting, or starting to play music, for example the light source could then be activated, for example, with brightness and color changing over time. An example of an effect could be glowing, flickering or fading-in. Thus, as time progresses, the brightness continually increases or increases or reduces in a pulsed manner, for example. The color can also be changed at the same time.

A separate control device can be used to control the light source. This control device can also be an integral component part of the loudspeaker assembly or also designed to be external thereto. The loudspeaker assembly accordingly has corresponding signal inputs for receiving a control signal. The simple application or varying of an operating voltage is also understood as “controlling” the light source.

If the loudspeaker assembly is integrated in a vehicle, the light pattern to be generated can be selected in accordance with a global vehicle setting, for example ambient lighting. The light source can also be controlled as a function of further factors, for example as a function of the music output by the loudspeaker.

Preferably, the coupling-in bridge is divided into at least two segments as viewed in the second direction, wherein each segment is assigned an individual and separately controllable light source and the segment boundary is designed in such a way that light is prevented from passing between the segments. The loudspeaker assembly according to the invention can thus be used for generating particularly abstract light patterns, which improves the visual appearance and hence the attractiveness even further. For instance, as viewed in the second direction, individual lamella groups can be illuminated or “switched on” gradually one behind the other. Different lamellas can also be lit up in different colors and/or with different brightness levels. Brightness and/or color gradients can thus be implemented. Static or dynamic lighting of the individual lamella groups is conceivable here as well. A respective segment can also be assigned multiple light sources, each having one or more lamps.

As already mentioned, an above-described loudspeaker assembly can advantageously be integrated in a vehicle. The vehicle can be any road vehicle such as a car, lorry van, bus or the like, or also a rail vehicle, watercraft or aircraft. The loudspeaker assembly can be installed in a road vehicle for example in the area of the instrument panel, the parcel shelf, the A-pillar, B-pillar, C-pillar, in the footwell, in a door trim or the like.

### BRIEF DESCRIPTION OF THE DRAWING FIGURES

Further advantageous configurations of the loudspeaker assembly according to the invention will also become apparent from the exemplary embodiments which are described in more detail hereinafter with reference to the figures, in which:

FIG. 1 shows a plan view of a loudspeaker assembly according to the invention;

FIG. 2 shows a plan view of the lamella underside of a lamella of a lamella grille functioning as a screen;

FIG. 3 shows a plan view of a loudspeaker assembly according to the invention with a cover attached to a coupling-in bridge;

FIG. 4 shows a sectional view through the section drawn in FIG. 1 through the lamella grille of the loudspeaker assembly; and FIG. 5 shows a plan view of an alternative loudspeaker assembly with multiple coupling-in bridges.

### DETAILED DESCRIPTION

FIG. 1 shows a loudspeaker assembly according to the invention comprising at least one loudspeaker 1, which in the plan view shown is arranged behind a screen 2. The screen 2 is a lamella grille 4 having a plurality of lamellas 4.1 that spread in a first direction x₁. The lamellas 4.1 block the loudspeaker 1 from view for an observer and serve inter alia as contact protection. The gap between the lamellas 4.1 is big enough that sufficient sound emitted from the loudspeaker 1 can penetrate through the screen 2. For the sake of clarity, only some identical features are provided with the same reference signs.

To achieve an appealing impression of the loudspeaker assembly, the latter also comprises a lighting device 3 in order to give the lamella grille 4 or the screen 2 a lighting effect. The loudspeaker assembly according to the invention provides for lighting the individual lamellas 4.1 of the lamella grilles 4, which, in contrast to a backlit loudspeaker as is known from the prior art, allows constant illumination over the entire viewing area of the screen 2, which contributes to a particularly aesthetic appearance of the loudspeaker assembly. Components used to light the lamellas 4.1 are hidden and thus not visible to the observer, which improves the optics even more.

The loudspeaker assembly according to the invention can also comprise component parts (not shown in more detail) such as a housing, supporting frame, or the like, to which the further components are fastened. This allows simple installation of the loudspeaker assembly on a superordinate structure 7 such as a vehicle part. The loudspeaker assembly can therefore be integrated in a vehicle, for example in the A-pillar, a door trim, a dashboard or the like.

In the examples illustrated in the figures, the screen 2 or the lamella grille 4 is square. However, in a plan view, the screen 2 can adopt any shape, for example a circular or oval shape or also a polygonal shape such as a triangular, trapezoidal or hexagonal shape or the like. The lamella grille 4 can also be configured geometrically such that in a plan view it has both corners and curves. The lamellas 4.1 may then extend as viewed in the first direction x₁ by different amounts, i.e. have a different width b. The lamellas 4.1 can be surrounded by a frame 4.2 on some or all edge sides.

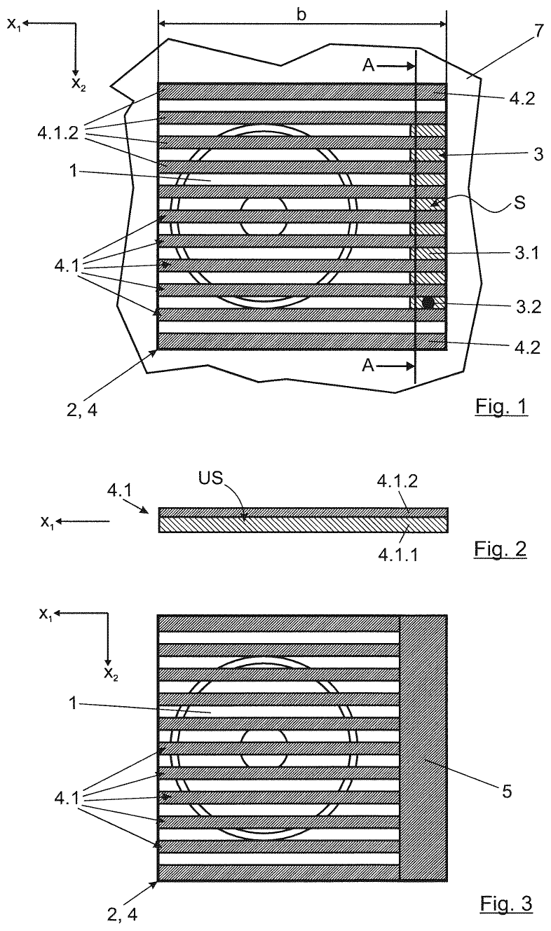

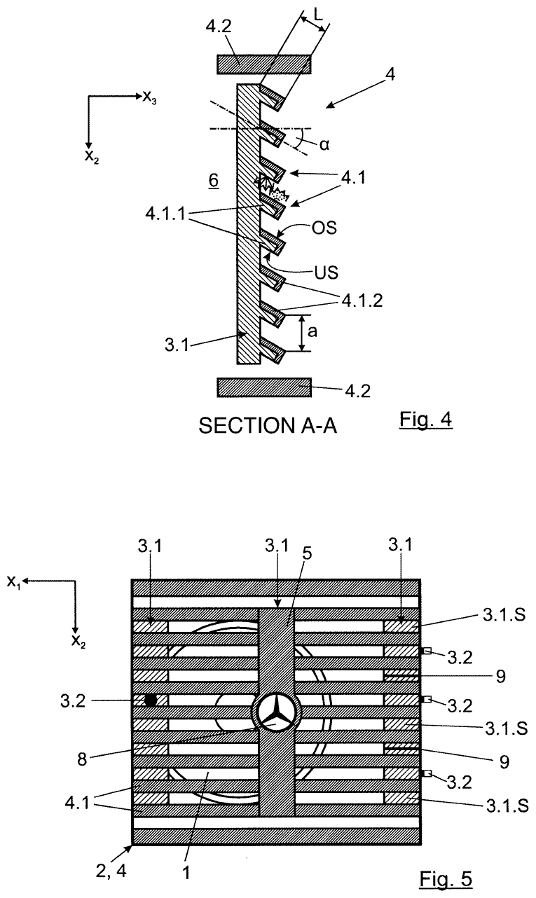

Some or preferably all of the lamellas 4.1 have, as shown in FIGS. 2 and 4, an integral design composed of a light-guiding structure 4.1.1 and a reflection structure 4.1.2. The light-guiding structure 4.1.1 is used to light a lamella top side OS shown in FIG. 4 and the reflection structure 4.1.2 is used to scatter or reflect the correspondingly received light. The light-guiding structure 4.1.1, together with a coupling-in bridge 3.1 and at least one light source 3.2, thus forms the lighting device 3. FIG. 2 illustrates a preferred embodiment, in which the light-guiding structure 4.1.1 extends over the full width b of a lamella 4.1.

The light source 3.2 can be a lamp or an arrangement of multiple lamps such as single-color or multicolored LEDs. Light emitted by the light source 3.2 is coupled into the coupling-in bridge 3.1 and propagates therein. The light source 3.2 can be arranged with respect to the coupling-in bridge in a known manner and at any suitable position.

The light then propagates out of the coupling-in bridge 3.1 into the light-guiding structures 4.1.1 of the individual lamellas 4.1 and correspondingly exits at a lamella underside US, also shown in FIG. 4. The coupling-in bridge 3.1 and the light-guiding structures 4.1.1 can be made of a single piece or of multiple pieces. A single-piece design is particularly preferred, which is produced by two-component injection molding. A multi-part design can be employed in the case of moving lamellas 4.1.

The light-guiding structures 4.1.1 and the coupling-in bridge 3.1 thus comprise a material transparent to the light emitted by the light source 3.2. The light-guiding components, i.e., the light-guiding structures 4.1.1 and the coupling-in bridge 3.1, can be designed in such a way that the light propagating within the structures is reflected comparatively strongly at the inner walls and can only exit slightly at the provided exit opening, namely at the lamella underside US, as a result of a low internal reflectance and correspondingly high transmittance being provided in this area. This ensures an efficient distribution of light.

As already mentioned, the light source 3.2 can be provided at any point for coupling into the coupling-in bridge 3.1, for example, as shown in FIG. 1, at an end of the coupling-in bridge 3.1 in a second direction x₂ viewed orthogonal to the first direction x₁. The light source 3.2 could, however, also be located further up towards the top, as viewed in the second direction x₂, for example centrally or on the upper edge of the coupling-in bridge 3.1. Multiple light sources 3.2 (not shown) distributed over the extent of the coupling-in bridge 3.1 could also be provided, for example one light source 3.2 for each illuminated lamella 4.1.

Since the loudspeaker 1 has no influence on the distribution of light along the screen 2, uniform illumination is also possible in the case of off-center positioning of the loudspeaker 1 in a plan view of the screen 2.

FIG. 3 shows an alternative design of the loudspeaker assembly, in which the coupling-in bridge 3.1 is provided with a cover 5 on a side S facing the observer (see FIG. 1). This further enhances the attractive visual appearance of the loudspeaker assembly, since it is thus reliably prevented that an observer notices any light undesirably exiting from the coupling-in bridge 3.1. Instead of a cover 5, an opaque coating can also be attached to the coupling-in bridge 3.1 at an appropriate point. The loudspeaker assembly can also be recessed in the superordinate structure 7 or in a housing in such a way that this housing or respectively the parts of the superordinate structure 7 conceal the coupling-in bridge 3.1 at least in some sections.

The cover 5 or coating can also deliberately have cutouts, in order to let certain light patterns appear to the observer, such as a pictogram or a logo 8 shown in FIG. 5. If the coupling-in bridge 3.1 lies between the loudspeaker 1 and lamella grille 4, individual lamellas 4.1 can also have corresponding cutouts for letting the light exiting the coupling-in bridge 3.1 pass through in order to realize the logo 8. The cover 5 can also be designed as a single piece with the lamellas 4.1, i.e. as a type of “connector”.

FIG. 4 shows the sectional view of the section A drawn in FIG. 1. FIG. 4 illustrates the integral design of the lamellas 4.1 consisting of light-guiding structures 4.1.1 and reflection structures 4.1.2. The lamellas 4.1 have an angle of inclination a and a length L. In addition, the individual lamellas 4.1 as viewed in the second direction x₂ are arranged with a mutual spacing. The individual parameters for the spacing a, the angle of inclination a and the length L can be adapted as required to customer requirements. For instance, the lamellas 4.1 can be designed so that a view through the lamella grille 4 onto a region 6 lying therebehind is blocked for an observer or left clear. In particular, the portion of light scattered or reflected in the direction of the region 6 can be controlled via the angle of inclination a so that the degree of illumination of the loudspeaker 1 behind the screen 2 can be controlled in a targeted manner. It may be desirable for the loudspeaker 1 not to be visible despite the lighting being activated. However, it may also be desired for the loudspeaker to be lit up particularly brightly and thus be clearly visible. One possible design provides that the angle of inclination a can be freely and continuously adjusted by a user, for example via a small wheel, folding lever or the like and a corresponding mechanism.

FIG. 4 also illustrates by way of arrows the propagation direction of the light coupled out of the light-guiding structures 4.1.1. Depending on surface properties of the reflection structure 4.1.2, the light is scattered and/or reflected. The extent of the scattering or reflection can be adjusted in a known manner, such as by changing the surface color and/or the surface structure of the reflection structures 4.1.2 at least on the lamella top side OS. A reflective material such as a chrome layer or a coating that gives the appearance of a chrome layer can also be applied to the lamella top side OS.

The coupling-in bridge 3.1 can also be offset in a third direction x₃ orthogonal to the first direction x₁ and second direction x₂, i.e., shifted further to the left or right in a view of FIG. 4. By way of example, the coupling-in bridge 3.1 can also lie substantially in one plane with the lamellas 4.1. To this end, the coupling-in bridge 3.1, as viewed in the first direction x₁, can then lie outside the boundary of the area taken up by the screen 2.

Of course, the entire lamella grille 4 lying in the plane could also be turned, so that the lamellas 4.1 in FIG. 4 would not point downwards, but upwards, or in direction towards an observer or away from them.

FIG. 5 shows a further alternative design of the loudspeaker assembly, in which multiple coupling-in bridges 3.1 are provided. FIG. 5 shows multiple alternative embodiments in combination. Preferably, a coupling-in bridge 3.1 is arranged on a lateral edge of the lamella grille 4 as viewed in the first direction x₁, as shown in FIG. 1. However, multiple coupling-in bridges 3.1 can also be provided, for example two, three or even more coupling-in bridges 3.1. By way of example, there can be three coupling-in bridges 3.1, as shown in FIG. 5, wherein two coupling-in bridges 3.1 are present on the two lateral edges as viewed in the first direction x₁ and one coupling-in bridge 3.1 is provided centrally. Particularly if the lamellas 4.1 have a comparatively large width b, a uniform distribution of light and therefore illumination of the screen 2 can thus be ensured.

FIG. 5 shows a further possible embodiment of a coupling-in bridge 3.1. This alternative design is illustrated with the coupling-in bridge 3.1 shown on the right in FIG. 5. This coupling-in bridge 3.1 is divided into multiple segments 3.1.S, with each of these segments 3.1.S being assigned an individual light source 3.2. A lateral arrangement of the light sources 3.2 with respect to the coupling-in bridge 3.1 is shown. A propagation of light across the segments 3.1.S is prevented by the introduction of a corresponding barrier layer 9. This barrier layer 9 is a comparatively thin layer made of a light-impermeable material. The individual light sources 3.2 can be controlled individually of one another. This enables dynamic lighting, for example by temporally alternating brightness and/or color effects. By separating the coupling-in bridge 3.1 into the segments 3.1.S, the lamellas 4.1 arranged one behind the other in the second direction x₂ can be lit up at different points in time. This enables animations to be implemented. For instance, the lamellas 4.1 can be lit up gradually and/or color gradients or brightness gradients can be realized in the second direction x₂. Similarly, the further coupling-in bridges 3.1 can also be divided into segments 3.1.S, which also allows color or brightness gradients to be provided in the first direction x₁.

With the aid of the loudspeaker assembly according to the invention, the lamella grille 4 can be demarcated from the superordinate structure 7 in a visually particularly aesthetic manner. This contributes to a particularly pleasing visual appearance. One or more such loudspeaker assemblies can be integrated in a vehicle, which has the result of enhancing the user experience for the vehicle occupant during a journey in the vehicle. Owing to the described method of construction, the loudspeaker assembly can be manufactured simply and cost-effectively. Since the light-guiding elements are integrated in the screen 2 or in the lamella grille 4, the provision of additional components needed for lighting can be dispensed with. This simplifies the design even further. The available installation space can accordingly be utilized efficiently. In addition, the lighting effect is not disrupted by the loudspeaker 1 that lies behind the screen 2 in the viewing direction.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A loudspeaker assembly with a lighting effect, the loudspeaker assembly comprising:
at least one loudspeaker;
a screen covering the at least one loudspeaker in a sound emission direction; and
a lighting device configured to shine light on the screen, wherein
the screen is formed by a lamella grille comprising at least two lamellas extending in a first direction;
at least some of the at least two lamellas are each formed by a light-guiding structure having an integral reflection structure,
the reflection structure has, on a lamella underside, a cutout extending in the first direction,
at least one of the light-guiding structures of the at least two lamellas is recessed the cutout in such a way that light coupled out of the light-guiding structure is castable onto a lamella top side of an adjacent lamella lying below the light-guiding structure; and
the lighting device is comprised of the light-guiding structures of the at least two
lamella, a coupling-in bridge, and at least one light source, light is couplable by the at least one light source into the coupling-in bridge, and the coupling-in bridge extends in a second direction orthogonal to the first direction and the light-guiding structures of the at least two lamella contact the coupling-in bridge or are a single piece with the coupling-in bridge so that light propagating in the coupling-in bridge is couplable into the light-guiding structures of the at least two lamella.

12. The loudspeaker assembly of claim 11, wherein the lamella grille is manufactured by two-component injection molding.

13. The loudspeaker assembly of claim 11, wherein, for at least one of the at least two lamellas, the cutout of the reflection structure and a respective light-guiding structure recessed in the cutout extend over a full width of the respective lamella in the first direction.

14. The loudspeaker assembly of claim 11, wherein at least one lamella top side of the at least two lamellas on which light can shine on through an adjacent lamella includes a light-reflecting coating or the reflection structure of the respective lamella comprises a light-reflecting material.

15. The loudspeaker assembly of claim 11, wherein the coupling-in bridge comprises a light-impermeable cover on a side of the coupling-in bridge in a plan view of the lamella grille.

16. The loudspeaker assembly of claim 11, wherein a ratio of lamella length, angle of inclination of the lamella, and spacing between the lamellas in the second direction is such that, in a plan view of the lamella grille, individual lamellas of the at least two lamellas block view of a region lying behind the lamella grille.

17. The loudspeaker assembly of claim 11, wherein the at least one loudspeaker is arranged outside a center of an area of the lamella grille in a plan view of the lamella grille.

18. The loudspeaker assembly of claim 11, wherein the at least one light source is controllable to generate a dynamic lighting effect in such a way that a brightness or color of the light emitted by the light source varies over time.

19. The loudspeaker assembly of claim 11, wherein the coupling-in bridge is divided into at least two segments as viewed in the second direction, wherein each segment of the at least two segments is assigned an individual and separately controllable light source and a segment boundary between the at least two segments is designed in such a way that light is prevented from passing between the at least two segments.

20. A vehicle comprising:
at least one loudspeaker assembly, which comprises
at least one loudspeaker;
a screen covering the at least one loudspeaker in a sound emission direction; and
a lighting device configured to shine light on the screen, wherein
the screen is formed by a lamella grille comprising at least two lamellas extending in a first direction;
at least some of the at least two lamellas are each formed by a light-guiding structure having an integral reflection structure,
the reflection structure has, on a lamella underside, a cutout extending in the first direction,
at least one of the light-guiding structures of the at least two lamellas is recessed the cutout in such a way that light coupled out of the light-guiding structure is castable onto a lamella top side of an adjacent lamella lying below the light-guiding structure; and
the lighting device is comprised of the light-guiding structures of the at least two lamella, a coupling-in bridge, and at least one light source, and
light is couplable by the at least one light source into the coupling-in bridge,
the coupling-in bridge extends in a second direction orthogonal to the first direction and the light-guiding structures of the at least two lamella contact the coupling-in bridge or are a single piece with the coupling-in bridge so that light propagating in the coupling-in bridge is couplable into the light-guiding structures of the at least two lamella.
